(19) United States
(12) Patent Application Publication
(10) Pub. No.: US 2011/0025517 A1
(43) Pub. Date: Feb. 3, 2011

(54) Power monitor controller, power monitor control system and power monitor control method

(75) Inventors: Mitsuru Kobayashi, Shinagawa (JP); Takaaki Hashimoto, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 12/805,412

(22) Filed: Jul. 29, 2010

(30) Foreign Application Priority Data
Jul. 30, 2009 (JP) 2009-178295

(51) Int. Cl. G08B 21/00

(52) U.S. Cl. 340/657

(57) ABSTRACT

A power monitor controller includes a period setting part that sets predetermined periods, an integrator part that integrates power consumed in an electric device for every predetermined period set by the period setting part to thus obtain first power consumption, and a detector part that detects an abnormality in the electric device when the first power consumption is within a predetermined range.

### CROSS-REFERENCE TO RELATED APPLICATION

This application is based upon and claims the benefit of priority of the prior Japanese Patent Application No. 2009-178295, filed on Jul. 30, 2009, the entire contents of which are incorporated herein by reference.

### FIELD

A certain aspect of the embodiments discussed herein is related to a power monitor controller, a power monitor control system and a power monitor control method.

### BACKGROUND

With the recent development of information and communication technology, a power monitor controller and a system using such a controller is utilized in order to collectively manage ON/OFF control of power supplies of electric equipment such as remote computers and servers.

An exemplary power monitor controller monitors current consumed in electric equipment to thus detect an abnormality of the electric equipment. In actually, there are some cases where current varies minutely due to inrush current and the type of load. In these cases, there is a difficulty in precisely detecting an abnormality of the electric equipment by the power monitor controller. Taking the above into consideration, another exemplary power monitor controller monitors the amount of power rather than current.

Japanese Patent Application Publication No. 2006-33441 discloses detection of an abnormality of electric equipment by detecting leakage current flowing in the electric equipment and integrating leakage power using a timer. Japanese Patent Application Publication No. 6-261470 discloses detection of an abnormality of electric equipment by obtaining the ratio of power consumed therein to the rated power capacity.

### SUMMARY

According to an aspect of the present invention, there is provided a power monitor controller including: a period setting part that sets predetermined periods; an integrator part that integrates power consumed in an electric device for every consumption; and a detector part that detects an abnormality in the electric device when the first power consumption is within a predetermined range.

### BRIEF DESCRIPTION OF THE DRAWINGS

FIG. 1 is a block diagram an exemplary configuration of a power monitor control system in accordance with a first embodiment;

FIG. 2 is a block diagram of a functional block diagram of a power monitor controller in accordance with the first embodiment;

FIG. 3 is a flowchart of a control sequence of the power monitor control system in accordance with the first embodiment;

FIG. 4 illustrates an example of power consumption obtained in the power monitor controller configured according to the first embodiment;

FIGS. 5A and 5B illustrate examples of power consumption obtained in the power monitor controller configured according to the first embodiment;

FIG. 6 is a flowchart of a control sequence of a power monitor controller in accordance with a second embodiment;

FIGS. 7A and 7B illustrate examples of power consumption obtained in a power monitor controller configured according to the second embodiment;

FIGS. 8A and 8B illustrate examples of power consumption obtained in a power monitor controller configured according to a third embodiment;

FIG. 9 is a flowchart of a control sequence of a power monitor control system in accordance with a fourth embodiment;

FIGS. 10A and 10B illustrate examples of power consumption obtained in a power monitor controller of the fourth embodiment;

FIGS. 11A and 11B illustrate examples of power consumption obtained in a power monitor controller of a fifth embodiment; and

FIGS. 12A and 12B illustrate examples of power consumption obtained in a power monitor controller of a sixth embodiment.

### DETAILED DESCRIPTION

A description will now be given, with reference to the accompanying drawings, of embodiments of the present invention.

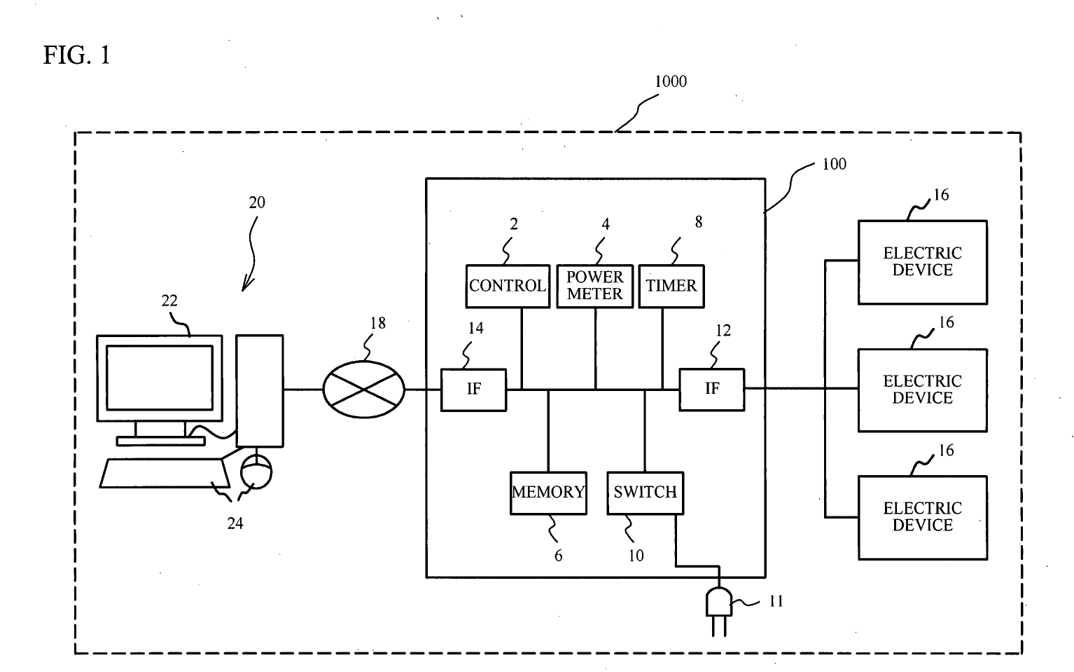

FIG. 1 is a block diagram of an exemplary structure of a power monitor control system in accordance with a first embodiment. A power monitor control system 1000 illustrated in FIG. 1 is configured as follows.

Referring to FIG. 1, the power monitor control system 1000 has a power monitor controller 100, electric devices 16 such as servers, and a control apparatus 20 such as a personal computer. The control apparatus 20 is remote from the power monitor controller 100 and the electric devices 16. The power monitor controller 100 and the control apparatus 20 are connected via a network 18, which may be the Internet. The power monitor controller 100 is configured as follows.

The power monitor controller 100 may be configured to include a control part 2, a power meter 4, a memory part 6, a timer 8, a switch part 10 and interfaces (I/F) 12 and 14. The control part 2 may be a central processing unit (CPU). The memory part 6 may include a read only memory (ROM) and a random access memory (RAM). The switch part 10 may be a power switch.

The control part 2 controls the power monitor controller 100. The power meter 4 integrates power consumed in the electric devices 16 for every predetermined period. The power meter 4 functions as an integrator. The memory part 6 stores the power consumption in the electric devices 16 for every predetermined period. The timer 8 measures the predetermined period, which may be changed by the user. The timer 8 may functions as a period setting part. The switch part 10 switches ON/OFF of a power supply to the electric devices 16. A plug 11 is connected to the switch part 10 and receives power connected thereto. The interface 12 establishes an interface between the power monitor controller 100 and the electric devices 16. The interface 14 establishes an interface between the power monitor controller 100 and the network 18. In other words, the interface 14 establishes an interface between the power monitor controller 100 and the control apparatus 20.

The control apparatus 20 has a display unit 22, which may be a liquid crystal display, an operation unit 24, which may include a keyboard, and a mouse.

The display unit 22 displays the power consumption obtained by integrating power measured by the power meter 4. The user may control the power monitor controller 100 by the operation unit 24 via the network 18. A description will now be given of operations of the power monitor controller 100 and the power monitor control system 1000.

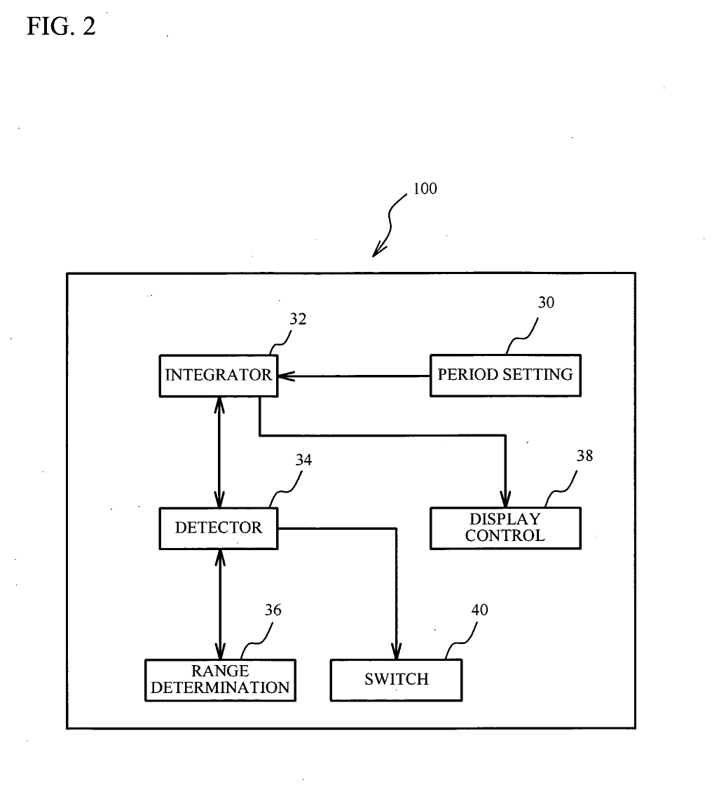

FIG. 2 is a functional block diagram of the power monitor controller 100. A period setting part 30 corresponds to the timer 8 illustrated in FIG. 1. An integrator part 32 corresponds to the power meter 4 illustrated in FIG. 1. A control part 2 functions as a detector part 34, a range determination part 36 and a display control part 38. A switch part 40 corresponds to the switch part 10 illustrated in FIG. 1.

The period setting part 30 sets the predetermined period. The integrator part 32 integrates power consumed in the electric devices 16 for every predetermined period. The power consumption thus obtained may be defined as a first power consumption. The power consumption of the electric devices 16 may be obtained by integrating current supplied to the electric devices 16 from the power monitor controller 100. When the power consumption obtained for every predetermined period is within a predetermined range, the detector part 34 determines that an abnormality takes place in any of the electric devices 16. The range determination part 36 determines the above predetermined range. The display control part 38 causes the power consumption obtained for every predetermined period by the integrator part 32 to be displayed on the display unit 22 of the control apparatus 20. The switch part 40 switches ON/OFF of the power supply to the electric devices 16 in response to the abnormality in the electric devices 16 determined by the detector part 34. That is, the switch part 40 performs the switching operation to prevent power supplied via the plug 11 from being supplied to the electric devices 16.

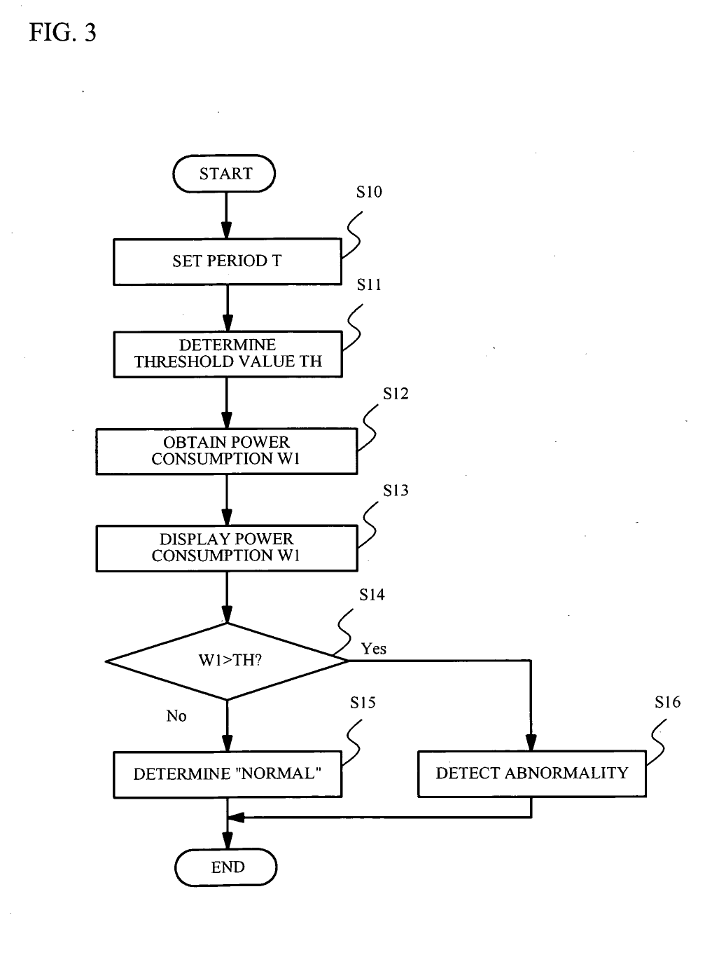

FIG. 3 is a flowchart of a control executed by the power monitor control system 1000.

Referring to FIG. 3, the period setting part 30 determines the predetermined period T during which the integrator part 32 integrates power consumed in the electric devices 16 (step S10). The user may arbitrarily determine the period T by using the period setting part 30. Following step S10, the range determination part 36 determines the predetermined range (step S11). In other words, the range determination part 36 sets a threshold value TH.

Following step S11, the integrator part 32 measures power consumption W1 of the electric devices 16 for every predetermined period T defined by the period setting part 30 (step S12). After step S12, the display control part 38 causes the integrated power consumption W1 to be displayed on the display unit 22 of the control apparatus 20 (step S13).

Subsequent to step S13, the detector part 34 determines whether the power consumption W1 measured by the integrator part 32 is greater than the predetermined threshold value TH (step S14). That is, the detector part 34 determines whether the power consumption W1 is within the predetermined range, which may be defined as a range over the predetermined threshold value TH.

When the answer of step S14 is NO, the detector part 34 determines that the electric devices 16 are normal (step S15). The switch part 40 is maintained in a position in which power is continuously supplied to the electric devices 16. In contrast, when the answer of step S14 is YES, the detector part 34 determines that an abnormality in the electric devices 16. In this case, the switch part 40 turns OFF the power supply to the electric devices 16. After step S15 or S16, the power monitor control system 1000 ends the control.

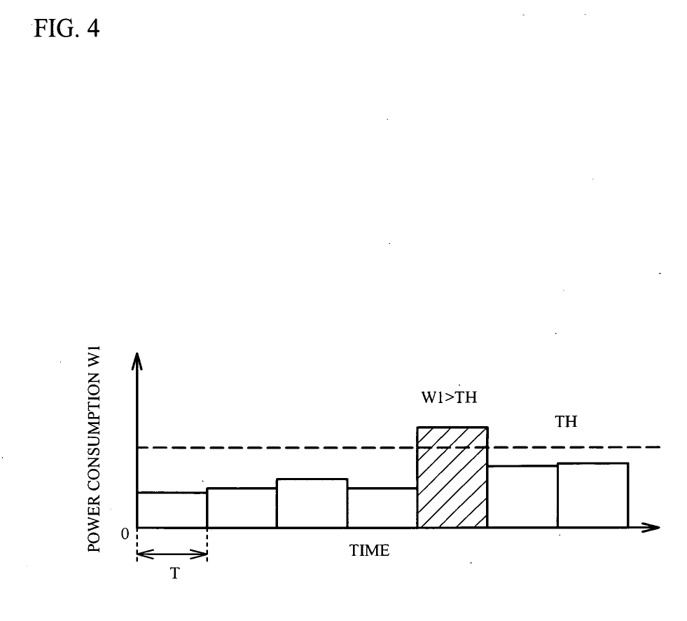

An exemplary control based on the power consumption W1 is now described below. FIG. 4 illustrates power consumption W1 measured for every predetermined period by the power monitor controller 100. The horizontal axis denotes time, and the vertical axis denotes the power consumption W1. A broken line in FIG. 4 is the threshold value TH determined by the range determination part 36.

As illustrated in FIG. 4, the integrator part 32 obtains the power consumption W1 of the electric devices 16 for every predetermined period T. The detector part 34 determines that the electric devices 16 have an abnormality in a period during which the power consumption W1 of the electric devices 16 is greater than the threshold value TH (the above period is illustrated with hatching).

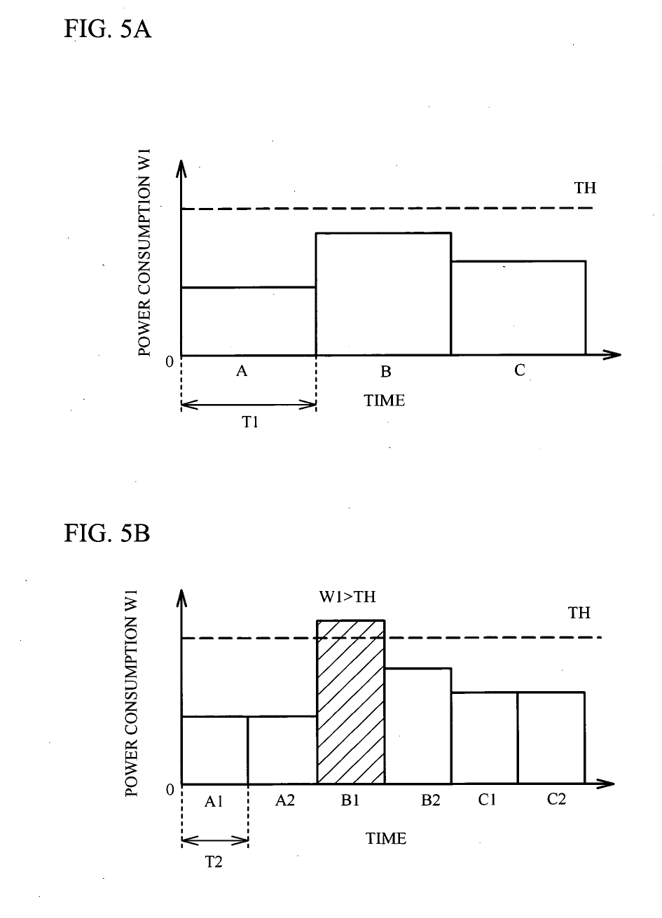

The predetermined period may be changed as follows. FIGS. 5A and 5B illustrate exemplary cases where the predetermined period is changed. More particularly, FIG. 5A illustrates a case where the power consumption W1 is obtained for every period T, and FIG. 5B illustrates another case where the predetermined period is changed to T2 from T1. For example, the predetermined period T1 may be 30 minutes and the predetermined period T2 may be 15 minutes.

In the case of FIG. 5A where power is integrated for every predetermined period T1 of 30 minutes, the power consumption W1 is lower than the threshold value TH in any of periods A, B and C. Thus, the detector part 34 does not determine that an abnormality takes place in the electric devices 16.

In the case of FIG. 5B where power is integrated for every changed predetermined period, namely, the period T2 of 15 minutes, the period A is divided into periods A1 and A2, the period B1 is divided into periods B1 and B2, and the period C is divided into periods C1 and C2. In the period B1, the power consumption W1 is greater than the threshold value TH. In this case, the detector part 34 determines that the electric devices 16 have an abnormality.

According to the first embodiment, the period setting part 30 is provided so that the user may arbitrarily determine the period T2 during which power consumed in the electric devices 16 is integrated by the integrator part 32. Thus, the power monitor controller 100 is capable of reliably detecting an abnormality of the electric devices, as has been described with reference to FIGS. 5A and 5B.

In the above description, when the detector part 34 detects an abnormality in the electric devices 16 (step S16 in FIG. 3), the switch part 40 turns OFF the power supply to the electric devices 16. The embodiment may be varied so that the power monitor controller 100 may notify the user of the detection of an abnormality in the electric devices 16. This notification may be made by sending the user an electronic mail.

The display control part 38 causes the power consumption illustrated in FIGS. 4, 5A and 5B to be displayed on the display unit 22 (step S13). Thus, the user may be easily aware of the occurrence an abnormality in the electric devices 16 from the power consumption displayed on the display unit 22. Further, the user may set the predetermined period T while confirming the power consumption displayed on the display unit 22. Thus, the user may easily set the period T most suitable for monitoring the electric devices 16.

The predetermined range, namely, the threshold value TH may be determined in such a manner that the user controls the power monitor controller 100 via the control apparatus 20 or may be determined automatically by the power monitor controller 100. The ON/OFF switching of the power supply to the electric devices 16 may be carried out by the user who uses the control apparatus 20, or may be carried out automatically by the power monitor controller 100. The period T may be one minute, five minutes, ten minutes, one hour, two hours, three hours, one day or one week.

A second embodiment is now described. The power monitor controller 100 and the power monitor control system 1000 have the same structural configurations as those employed in the first embodiment illustrated in FIGS. 1 and 2.

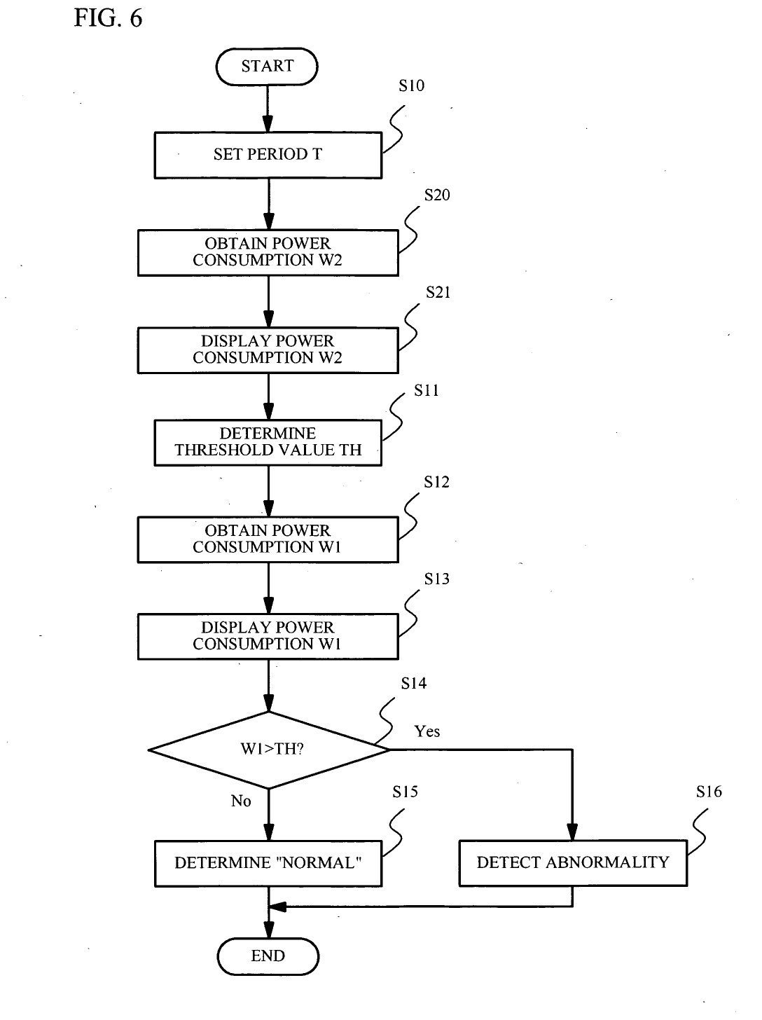

FIG. 6 is a flowchart of a control carried out by the power monitor control system 1000 in accordance with the second embodiment.

As illustrated in FIG. 6, the period setting part 30 sets the predetermined period T during which power is integrated by the integrator part 32 (step S10). Following step S10, the integrator part 32 obtains power consumption W2 in the electric devices 16 for every predetermined period T defined by the period setting part 30 (step S20). Following step S20, the display control part 38 causes the power consumption W2 in the electric devices 16 to be displayed on the display unit 22 of the control apparatus 20 (step S21). The control from step S11 to S16 is the same as that illustrated in FIG. 3.

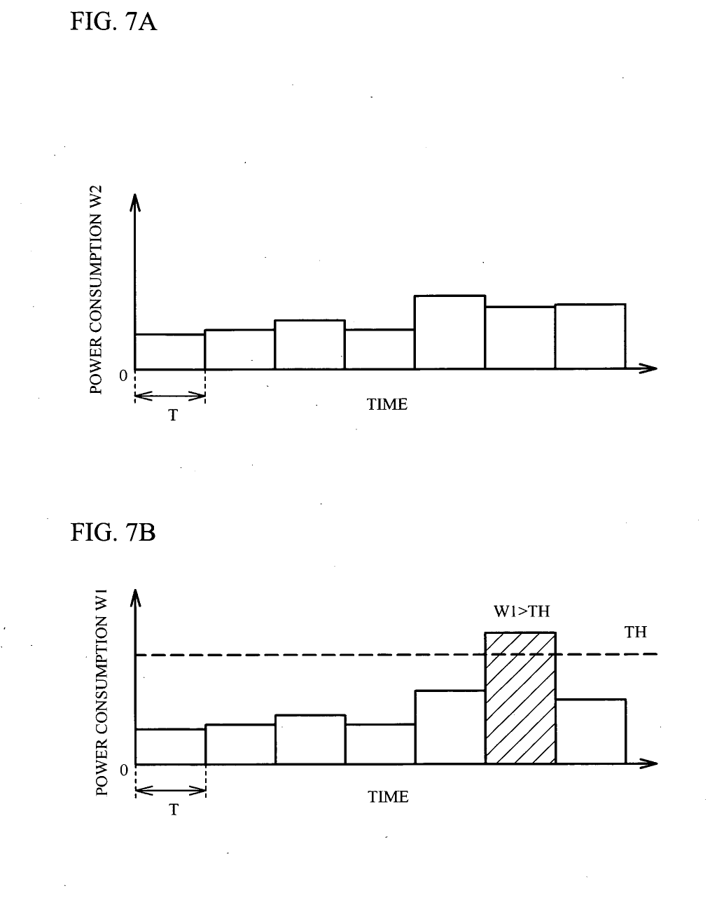

The power consumptions W2 and W1 are further described below. FIG. 7A illustrates an example of the power consumption W2, and FIG. 7B illustrates an example of the power consumption W1.

As illustrated in FIG. 7A, the integrator part 32 integrates power consumed for every predetermined period T set by the period setting part 30 and thus obtains the power consumption S2 (step S20 in FIG. 6). During the periods T for power integration, no abnormality takes place in the electric devices 16. The memory part 6 stores the period T and the power consumption W2 for each period T.

As illustrated by a broken line in FIG. 7B, the range determination part 36 determines the predetermined range, that is, the threshold value TH on the basis of the power consumption W2 stored in the memory part 6 (step S11 in FIG. 6).

As illustrated in FIG. 7B, the integrator part 32 integrates power consumed in the electric devices 16 for every predetermined period T to obtain the power consumption W1 (step S12 in FIG. 6). In other words, the integrator part 32 obtains the power consumption W2 for every predetermined period T, and thereafter, obtains the power consumption W1 for every same period T as that for obtaining the power consumption W2. The detector part 34 determines that an abnormality takes place in the electric devices 16 in a specific period in which the power consumption W1 is greater than the threshold value TH.

According to the second embodiment, the range determination part 36 determines the predetermined range, that is, the threshold value TH on the basis of the power consumption W2 that are obtained for every same period T as the period T previously used to obtain the power consumption W1 in a state in which the electric devices 16 are normal. Thus, the range determination part 36 determines the most suitable threshold value TH. Thus, according to the second embodiment, the range determination part 36 may detect abnormality of the electric devices 16 more reliably.

The display control part 38 causes the power consumption as illustrated in FIGS. 7A and 7B to be displayed on the display unit 22 of the control apparatus 20 (steps S21 and S13 in FIG. 6). Thus, the user determines the period and threshold value TH while confirming the power consumption W2 displayed on the display unit 22. It is thus possible for the user to easily suitable conditions for monitoring the electric devices 16 (the period and threshold value TH) and to easily detect an abnormality of the electric devices 16. The range determination part 36 may determine the threshold value TH automatically.

The range determination part 36 may determine the range in the following exemplary ways. The range determination part 36 may use the greatest one of the power consumptions W2 obtained in the past in order to determine the threshold value TH. The range determination part 36 may use the average of the power consumptions W2 obtained in the past in order to determine the threshold value TH.

A third embodiment is now described. The power monitor controller 100 and the power monitor control system 1000 have the same structural configurations as those employed in the first embodiment illustrated in FIGS. 1 and 2. The control carried out by the power monitor control system 1000 is the same as that illustrated in FIG. 6.

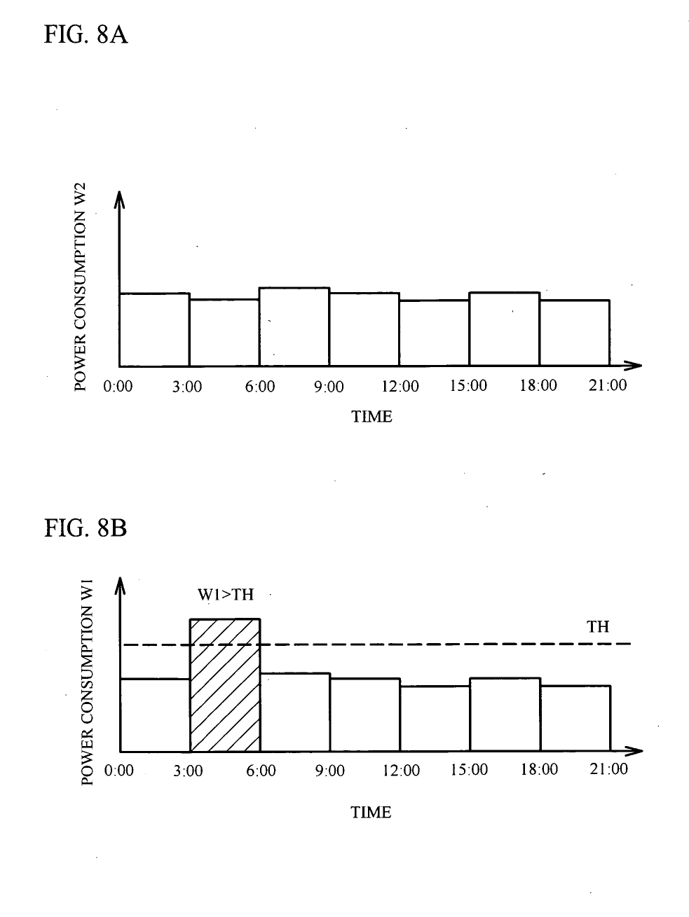

Examples of the power consumptions W2 and W1 are now described. FIG. 8A illustrates an example of the power consumption W2, and FIG. 8B illustrates an example of the power consumption W1.

As illustrated in FIG. 8A, the period setting part 30 determines the period for integrating power by the integrator part 32 by dividing one day into equal periods of time (step S10 in FIG. 6). In the case of FIG. 8A, one day is divided into periods of time every three hours. The integrator part 32 integrates power consumed in the electric devices 16 for every period thus determined by the period setting part 30 (step S20). In the case of FIG. 8A, no abnormality takes place in the electric devices 16 during any of the periods. The memory part 6 stores the period and the power consumption W2.

For example, the activity of the electric devices 16 is low from three o'clock to six o'clock, and the power consumption W2 during this period is small. The range determination part 36 determines the threshold value TH on the basis of the power consumption W2. (step S11).

As illustrated in FIG. 8B, the integrator part 32 integrates power consumed in the electric devices 16 during the same period as that for obtaining the power consumption W2. The detector part 34 determines that an abnormality takes place in the electric devices 16 when the power consumption W1 is greater than the threshold value TH (steps S14, S15 and S16):

In the normal case illustrated in FIG. 8A, the activity of the electric devices 16 is low from three o'clock to six o'clock. In contrast, the power consumption S1 illustrated in FIG. 8B is greater than the threshold value TH in the period of three o'clock to six o'clock. Thus, the detector part 34 determines that an abnormality took place in the period of three o'clock to six o'clock.

According to the third embodiment, the integrator part 32 measures the power consumption W2 and the power consumption W1 for the same periods. The range determination part 36 determines the suitable threshold value TH on the basis of the power consumption W2 obtained when the electric devices 16 are normal. Thus, as illustrated in FIGS. 8A and 8B, the power monitor controller 100 may reliably detect an abnormality in the electric devices 16 on the basis of the degree of activity of the electric devices 16 obtained for every period.

The detector part 34 detects an abnormality of the electric devices 16 when the power consumption W1 is greater than the threshold value TH. Thus, as in the case of power consumption W1 is greater than the threshold value TH. Thus, as in the case of the period from three o'clock to six o'clock, the detector part 34 may easily detect an abnormality of the electric devices 16 when these devices have a low activity in the normal state.

The period used to obtain the time consumption by the integrator part 32 is not limited to three hours but may be 30 minutes, 1 hour, 2 hours, 6 hours, 12 hours and 24 hours. The periods to be compared are not limited to identical periods within one day but may be an identical day of week or an identical day of month. The periods to be compared may be a specific day of month such as the first Saturday every month.

A fourth embodiment is now described. The power monitor controller 100 and the power monitor control system 1000 have the same structural configurations as those employed in the first embodiment illustrated in FIGS. 1 and 2.

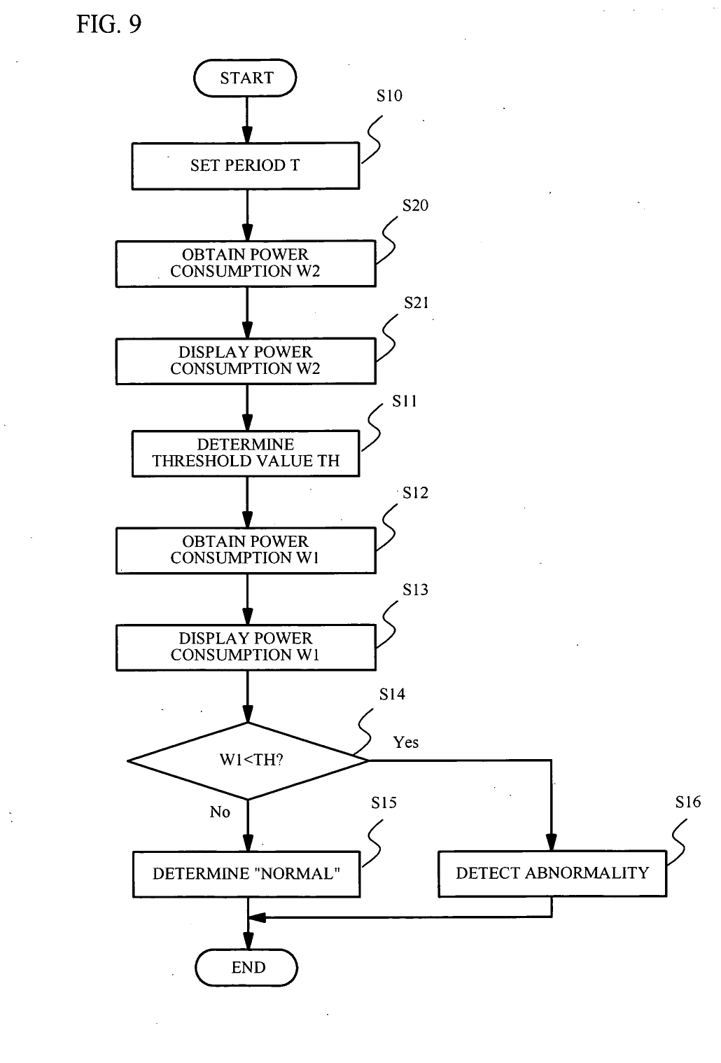

The power monitor control system 1000 carries out the following control. FIG. 9 is a flowchart of the control by the power monitor control system 1000 in accordance with the fourth embodiment.

As illustrated in FIG. 9, the detector part 34 determines whether the power consumption W1 obtained by the integrator part 32 is lower than the threshold value TH (step S14). That is, the detector part 34 determines whether the power consumption W1 is within the predetermined range. It is to be noted that the predetermined range is a range lower than the predetermined threshold value TH.

When the answer of step S14 is NO, the detector part 34 determines that the electric devices 16 are normal (step S15). The switch part 40 maintains the position of supplying power to the electric devices 16. When the answer of step S14 is YES, the detector part 34 determines that an abnormality takes place in the electric devices (step S16). The switch part 40 turns OFF the power supply to the electric devices 16.

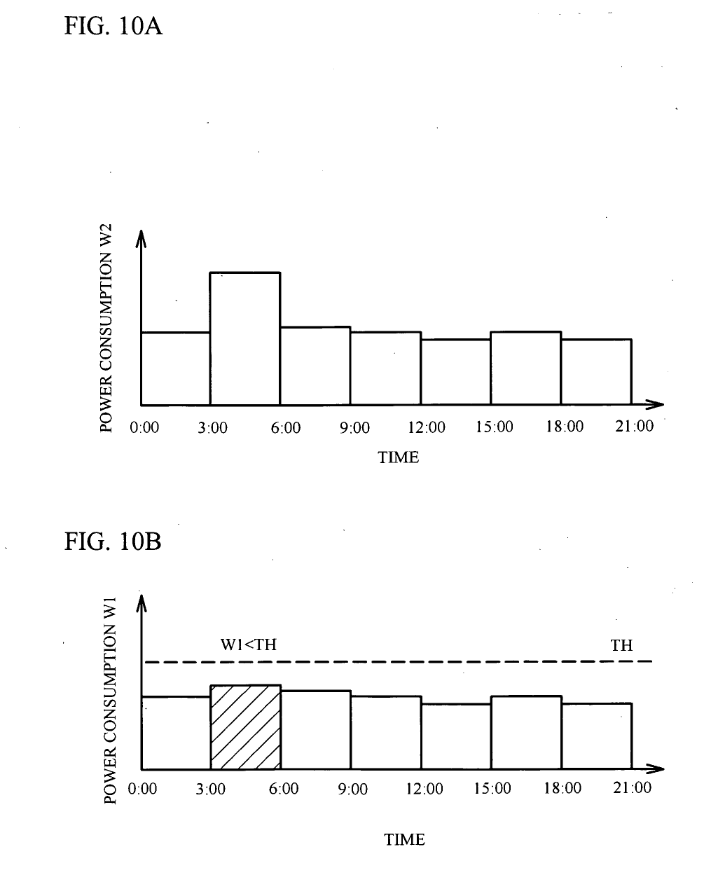

Examples of the power consumptions W2 and W1 are now described. FIG. 10A illustrates an example of the power consumption W2, and FIG. 10B illustrates an example of the power consumption W1.

Referring to FIG. 10A, the electric devices 16 have high activity during the period from three o'clock to six o'clock and have a large amount of the power consumption W2. In contrast, during the period from eighteen o'clock to twenty-one o'clock, the electric devices 16 has low activity and has a small amount of the power consumption W2. The range determination part 36 determines the threshold value TH on the basis of the power consumption W2.

As illustrated in FIG. 10B, in the normal state, the power consumption W1 is lower than the threshold value TH in the period from three o'clock to six o'clock in which the activity of the electric devices 16 is high. The detector part 34 determines an abnormality occurs in the electric devices 16 in the period from three o'clock to six o'clock. In the periods other than the period from three o'clock to six o'clock, the detector part 34 detects an abnormality in the electric devices 16 when the power consumption W1 is greater than the threshold value TH as in the case of the third embodiment.

According to the fourth embodiment, the power monitor controller 100 reliably detects an abnormality in the electric devices 16 by checking the activity thereof obtained for every period as in the case of the third embodiment. When the power consumption W1 is lower than the threshold value TH, the detector part 34 detects an abnormality in the electric devices 16. Thus, an abnormality in the electric devices 16 may easily be detected in the case where there is a period in which the activity of the electric devices 16 is high in the normal state, such as the period from three o'clock to six o'clock illustrated in FIG. 10B.

It is possible to separately use, on the period base, a determination (the period from three o'clock to six o'clock) in which the electric devices 16 have an abnormality when the power consumption W1 is lower than the threshold value TH and another determination (the periods other than the period from three o'clock to six o'clock) in which the electric devices 16 have an abnormality when the power consumption W1 is greater than the threshold value TH. In other words, it is possible to change the predetermined range defined by the range determination part 36 on the period base. It is thus possible to reliably detect an abnormality in the electric devices 16 taking the periods into consideration. The first and second embodiments may be varied so that the detector part 34 detects an abnormality in the electric devices 16 when the power consumption W1 is lower than the threshold value TH.

The range determination part 36 may determine the range as follows. The range determination part 36 may determine the range on the basis of the smallest one of the power consumptions W2 obtained in the past or the average of the power consumptions W2 obtained in the past.

A fifth embodiment is now described. The power monitor controller 100 and the power monitor control system 1000 have the same structural configurations as those employed in the first embodiment illustrated in FIGS. 1 and 2.

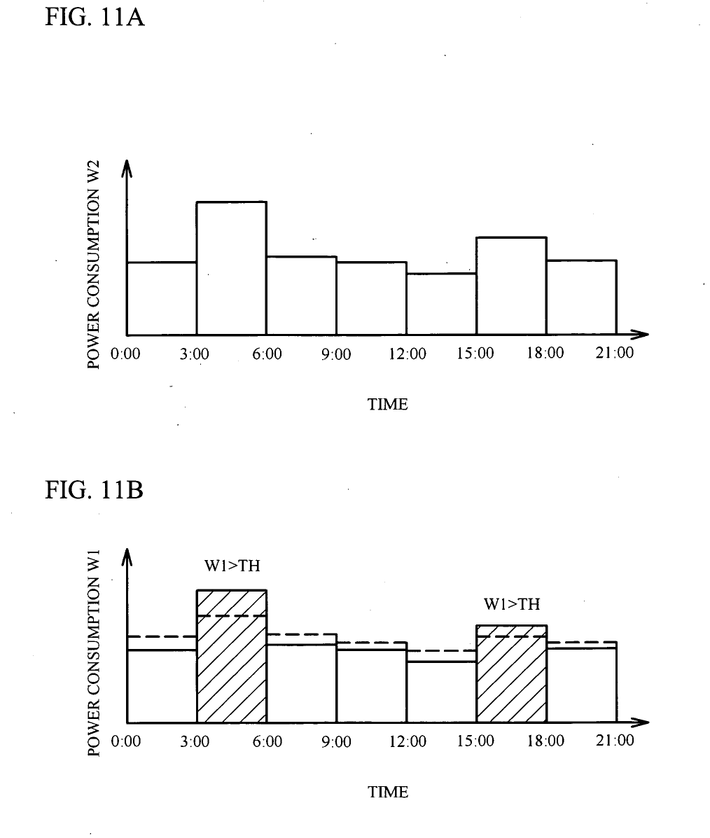

The control of the power monitor control system 1000 of the fifth embodiment is the same as that illustrated in FIG. 6. Examples of the power consumptions W2 and W1 are described bellows. FIG. 11A illustrates an example of the power consumption W2, and FIG. 11B illustrates an example of the power consumption W1.

As illustrated in FIG. 11A, the integrator part 32 integrates power consumed in the electric devices 16 for every period defined by the period setting part 30 to thus obtain the power consumption W2 for every predetermined period.

As illustrated in FIG. 11B, the range determination part 36 determines the threshold value TH for every predetermined period defined by the period setting part 30. The threshold value TH thus determined is the greatest during the period of three o'clock to six o'clock and is the smallest during the period of fifteen o'clock to eighteen o'clock. The detector part 34 detects an abnormality in the electric devices 16 during the above two periods in which the power consumption W1 is greater than the threshold values TH.

According to the fifth embodiment, the integrator part 32 integrates power for every predetermined period, and the range determination part 36 determines the range on the period base. It is thus possible to reliably detect an abnormality in the electric devices 16 on the period base.

The range determination part 36 may determine the range as follows. The range determination part 36 may determine the threshold value TH on the basis of the greatest one of the power consumptions W2 obtained in the past or the smallest one. The range determination part 36 may the range on the basis of the average of the power consumptions W2 obtained h the past.

A sixth embodiment is now described. The power monitor controller 100 and the power monitor control system 1000 have the same structural configurations as those employed in the first embodiment illustrated in FIGS. 1 and 2. The control of the power monitor control system 1000 is the same as illustrated in FIG. 6.

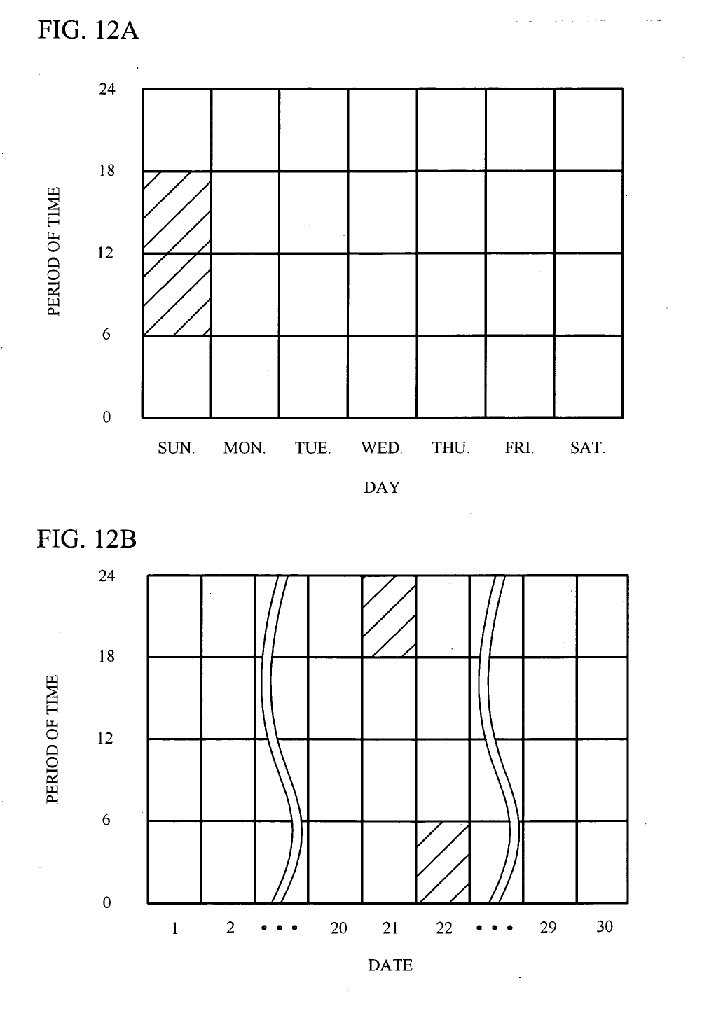

The period used in the sixth embodiment is as follows. FIGS. 12A and 12B illustrate exemplary periods monitored by the power monitor controller of the sixth embodiment. The vertical axes of FIGS. 12A and 12B denote the periods of time. The horizontal axis of FIG. 12A denotes the days of week and that of FIG. 12B denotes dates of month.

In the example illustrated in FIG. 12A, the power consumption of the electric devices 16 is monitored during a period from six o'clock to eighteen o'clock on Sunday and another period from twenty-one o'clock to twenty-four o'clock on Friday, as illustrated with hatching.

In the example illustrated in FIG. 12B, power consumed by the electric devices 16 is monitored during a period from eighteen o'clock on twenty first to six o'clock on twenty second, as illustrated with hatching. In the periods of time, the power monitor control system 1000 carries out the controls as illustrated in FIGS. 6 and 9.

According to the sixth embodiment, the multiple periods are combined by the period setting part 30 so that the range for monitoring the electric devices 16 is determined. It is thus possible to more adequately the activity of the electric devices 16 and optimize the condition for monitoring the electric devices 16. The power monitor controller 100 reliably detects an abnormality in the electric devices 16 considering the activity of the electric devices 16 obtained on the period base. The electric devices 16 may be monitored routinely.

The sixth embodiment that employs the combination of multiple periods of time may be varied so as to employ a combination of day and period or another combination of date and period. For example, it is possible to employ a period from six o'clock to twelve o'clock on the last day of every month or another period from zero o'clock to six o'clock on the first Monday of every month. That is, the period may have a combination of a specific date of month and a period of time or another combination of a specific day of week and a period of time.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A power monitor controller comprising:
a period setting part that sets predetermined periods;
an integrator part that integrates power consumed in an electric device for every predetermined period set by the period setting part to thus obtain first power consumption; and
a detector part that detects an abnormality in the electric device when the first power consumption is within a predetermined range.

2. The power monitor controller according to claim 1, wherein the integrator part integrates power consumed in the electric device for every period that corresponds to the predetermined periods to thus obtain a second power consumption before obtaining the first power consumption.

3. The power monitor controller according to claim 2, further comprising a range determination part configured to determine the predetermined range on the basis of the second power consumption, wherein the detector part detects an abnormality in the electric device when the first power consumption is within the predetermined range determined by the range determination part.

4. The power monitor controller according to claim 1, wherein the predetermined range has different values for the predetermined periods.

5. The power monitor controller according to claim 1, wherein the predetermined range is defined do that the first power consumption is greater than a predetermined threshold value.

6. The power monitor controller according to claim 1, wherein the predetermined range is lower than a predetermined threshold value.

7. The power monitor controller according to claim 1, further comprising a display control part configured to cause the first power consumption obtained for every predetermined period to be displayed on a display part.

8. The power monitor controller according to claim 2, wherein the period setting part sets the predetermined period having a combination of multiple periods.

9. A power monitor control system comprising:
a power monitor controller connected to an electric device; and
a control apparatus that is remote from the electric device and the power monitor controller and is connected to the power monitor controller and that controls the power monitor controller,
the power monitor controller including:
a period setting part that sets predetermined periods;
an integrator part that integrates power consumed in the electric device for every predetermined period set by the period setting part to thus obtain first power consumption; and
a detector part that detects an abnormality in the electric device when the first power consumption is within a predetermined range.

10. The power monitor control system according to claim 9, further comprising a display part, wherein the power monitor controller includes a display control part configured to cause the first power consumption obtained for every predetermined period to be displayed on the display part.

11. A power monitor control method comprising:
setting predetermined periods;
integrating power consumed in an electric device for every predetermined period to thus obtain first power consumption; and
detecting an abnormality in the electric device when the first power consumption is within a predetermined range.
